(19) United States
(12) Patent Application Publication
(10) Pub. No.: US 2005/0015274 A1
(43) Pub. Date: Jan. 20, 2005

(54) Fennell hierarchy for marketable product categorization

(76) Inventors: David Fennell, Redwood City, CA (US); Diane Schechinger, Half Moon Bay, CA (US)

Correspondence Address: Diane Schechinger, 441 Alameda Avenue, Half Moon Bay, CA, 94019, US

(21) Appl. No.: 10/889,374

(22) Filed: Jul. 12, 2004

Related U.S. Application Data
(60) Provisional application No. 60/487,395, filed on Jul. 14, 2003.
(60) Provisional application No. 60/536,805, filed on Jan. 16, 2004.
(60) Provisional application No. 60/547,177, filed on Feb. 25, 2004.

(51) Int. Cl. G06F 17/60

(52) U.S. Cl. 705/1

(57) ABSTRACT

The use of computer technology and the internet to quickly locate, view, compare, and select marketable products or other data. The growth of the internet has exceeded the capacity of existing technologies and business methods to allow business and consumer users to sort through a vast sea of data. The Fennell Hierarchy builds upon the simple concept of organizational hierarchy, and applies it in a specific manner through the internet to the marketplace, in which all conceivable products, whatever their use or country of manufacture, can be located and isolated within the hierarchy The invention uses a hierarchy-based software system that will allow the computer user to search and find required data directly. The user will no longer waste time sifting through search results that are outside the needs of his current search.

### CROSS-REFERENCE TO RELATED APPLICATIONS

A. World.info PPA#1, “Schechinger/Fennell System and Method for Categorization of Data,” filed Jul. 14, 2003, PTO Appl. No. 60/487,395

B. World.info PPA #2, “Schechinger/Fennell System and Method for Data Display Using Variable Field Headings,” filed Jan. 16, 2004, PTO Appl. No. 60/536,805

C. World.info PPA #3, “Schechinger/Fennell System and Method for Organization and Display of Data and Identification of Key Data for Comparison and Analysis, filed (mailed) Jan. 12, 2004, no PTO # on file

D. World.info PPA #4, “Schechinger/Fennell System and Method for Filtering Search Results by Utilizing User-Selected Parametric Values from a Self-Defined Drop-Down List on a Website,” filed (mailed) Feb. 23, 2004, no PTO # on file

E. World.info PPA #5, “Schechinger/Fennell System and Method for filtering Data Search by Utilizing User Selected Checkboxes, filed Feb. 25, 2004, PTO Appl. No. 60/547,177

F. World.info PPA #6, “Schechinger/Fennell/Hirzel System and Method for Associating Unlimited Numbers of Parametric Names and Values to a Specific Product and the Ability to Select or Deselect for Viewing the Results on a Parametric Display Page,” filed (mailed) Jun. 7, 2004, no PTO # on file

G. World.info PPA #7, “Schechinger/Fennell System and Method for Finding Specific Products that Meet Exact User Defined Requirements in Three Clicks.” Filed (mailed) Jun. 7, 2004, no PTO # on file

### BACKGROUND OF THE INVENTION

1. Field of the Invention

This invention relates to, but is not limited to, the use of computer database and software technology and the internet to locate, view, compare, and select marketable products or other data.

2. Prior Art

Since the advent of the personal computer, the internet has truly become the “World-wide web,” with terminals in every nation linked to each other sharing information and transmitting data in quantities and at speeds undreamed of even a decade ago. The growth of the internet has exceeded the capacity of existing technologies and business methods to allow business and consumer users to access, compare, and sort items of a like kind in a comprehensible manner from this vast ocean of unorganized data.

Existing methods of filtering information from computer databases, commonly known as “search engines,” which can be found in websites such as “Google.com,” “Vehix.com,” “Globalspec.com,” and others, are either too nonspecific, or too restrictive in their approach, and do nothing meaningful to organize the countless reams of marketing data into an instantly usable and understandable format. Using the current art of only associating words without a hierarchy, it is impossible to drill quickly down to the level of specific products. In using Google, for instance, one types in the key word or words to their search, and finds himself looking at page one of, say, 813,000 pages of website listings, arranged in no particular order, each of which has his chosen words appearing in it (the words themselves often in no particular order) through which, if he is to consider his search complete, he must wade, one by one. One finds, for instance, on entering “Sinks,” references to “Titanic sinks,” “heat sinks,” and a basketball player “sinks one,” when the user was looking for a lavatory sink for his home. Vehix.com and Globalspec claim to offer side-by-side comparisons of specific products, but these are limited to small segments of the marketplace, and one must know of these sites, and their marketing angles in order to find them of any use at all. Other methods for product search include “phone-book” type directories of business names and addresses, with no capacity for product search at all (FIG. 1). For all those companies who do not pay to have their products listed in these sites, there is no universal method or site which enables them to be quickly and easily located.

Once the user has entered such a site, he is obliged to navigate, using the familiar “point-and-click” process, through a varying number of discrete steps, from the website's hone page, through that site's unique system of organization. Eventually, he may find that product whose combination of features and attributes meets his needs, most frequently in a multitude of clicks. The user often gets lost in the complex site navigation unique to each website, having never found the products of interest. For all those companies who do not pay to have their products listed in these sites, there is no universal method or site which enables these products to be quickly and easily located. It is at best a laborious, inefficient process, yielding doubtful results

### OBJECTS AND ADVANTAGES

A. The hierarchy imposes simplicity and order on a wildly chaotic universe of disorganized and inaccessible data.

B. With the universe of data thus ordered, the location of specific product types within it, and the relationships of specific types to other, similar types, with which they may be easily confused, is easily and accurately determined.

C. With products thus displayed as fields within this hierarchy, the work of seeking out specific product types for comparison of key specifications and purchase by purchasing agents, engineers, and designers, and others is rendered more efficient.

D. This hierarchical system of categorization is an integral part of the World.info product search engine, of which the PPAs referenced in II above describe some, but not all, other patentable aspects.

E. The system can be used over the internet and will be accessible to end-users who have computers with internet access. Installation of software at computer terminals will not be required.

F. All products from all vendors are similarly displayed. This allows small business enterprise to compete on an equal footing with large corporations, encouraging innovation throughout the marketplace.

### SUMMARY OF THE FENNELL HEIRARCHY

The invention is a method of organizing products in a fashion to quickly get to a short list of only products of a like kind, using a hierarchy-based software system that will allow the computer user to search and find required data directly. With the creation of a hierarchical, branching system, data for any product can be quickly and easily located for viewing, to be compared and contrasted with that of similar products of a like type. Without this system, any comparison is meaningless, as search results cannot be made to be “apples-to-apples.” With our new invention the user will no longer have to take the time to sift through endless search results that are outside the needs of his current search.

### FIGURES

FIG. 1: Current Art: Search Engine or “Yellow Pages”

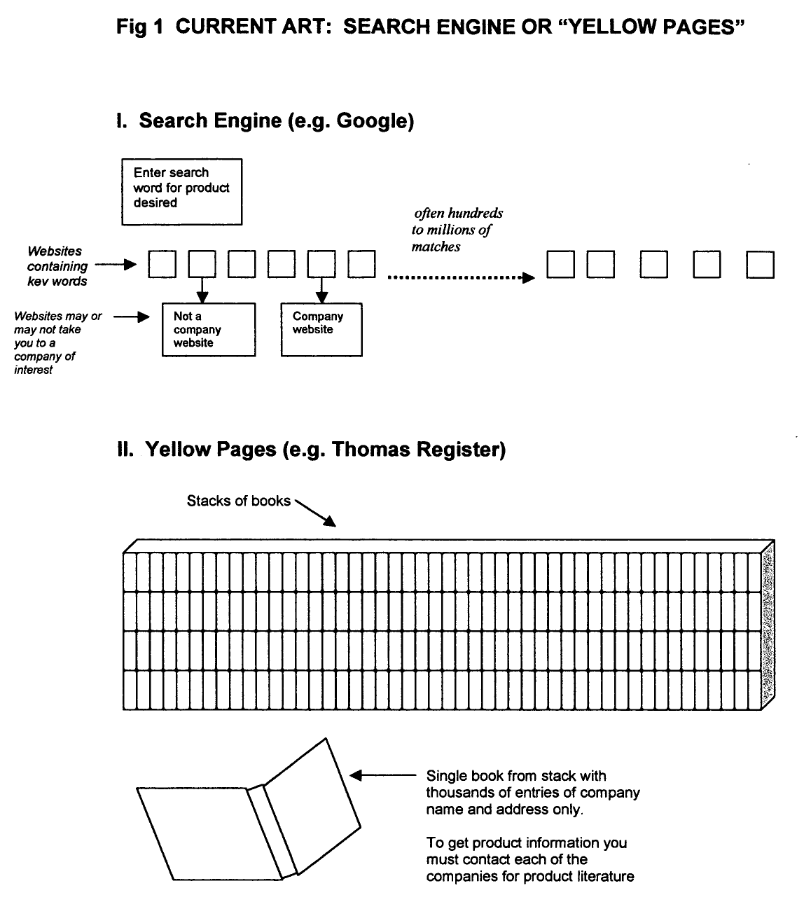

FIG. 2: Examples of Product Types showing a function of Similarity of Key Parameters and Function

FIG. 3: Creating Database Files for Hierarchy Showing Relationships

FIG. 4: Illustration of Hierarchy

FIG. 5: Flow Chart Example of Hierarchy System

FIG. 6A: Examples of Searching Hierarchies to Find Lke Products

FIG. 6B: Other Examples of Searching Hierarchies to Find Like Products

FIG. 7: Schematic Diagram Of Hardware and Software Relationships

### DETAILED DESCRIPTION

The Fennell Hierarchy builds upon the simple concept of organizational hierarchy, and applies it in a specific manner through the internet to the marketplace, in which all conceivable products, whatever their use or country of manufacture, can be located and isolated within the hierarchy. When used in conjunction with the World.info website database and search process referenced above, it enables the user to immediately determine exactly which product type (lavatory, heat, commercial, etc.) of a variety of possible “sinks,” for example, (see Google example above) is the appropriate place to begin his search for a specific product, with no confusion and no time wasted.
Every marketable product has a specific place in the hierarchy
The concept of a hierarchy is a simple one, universally understood, but never before applied to commercial activity in this comprehensive manner
With only six degrees of separation, the entire hierarchy surrounding the product type entered is immediately visible and comprehensible
With this immediate and unmistakable product type identification, the user's search is greatly facilitated toward the next step, comparison of like products

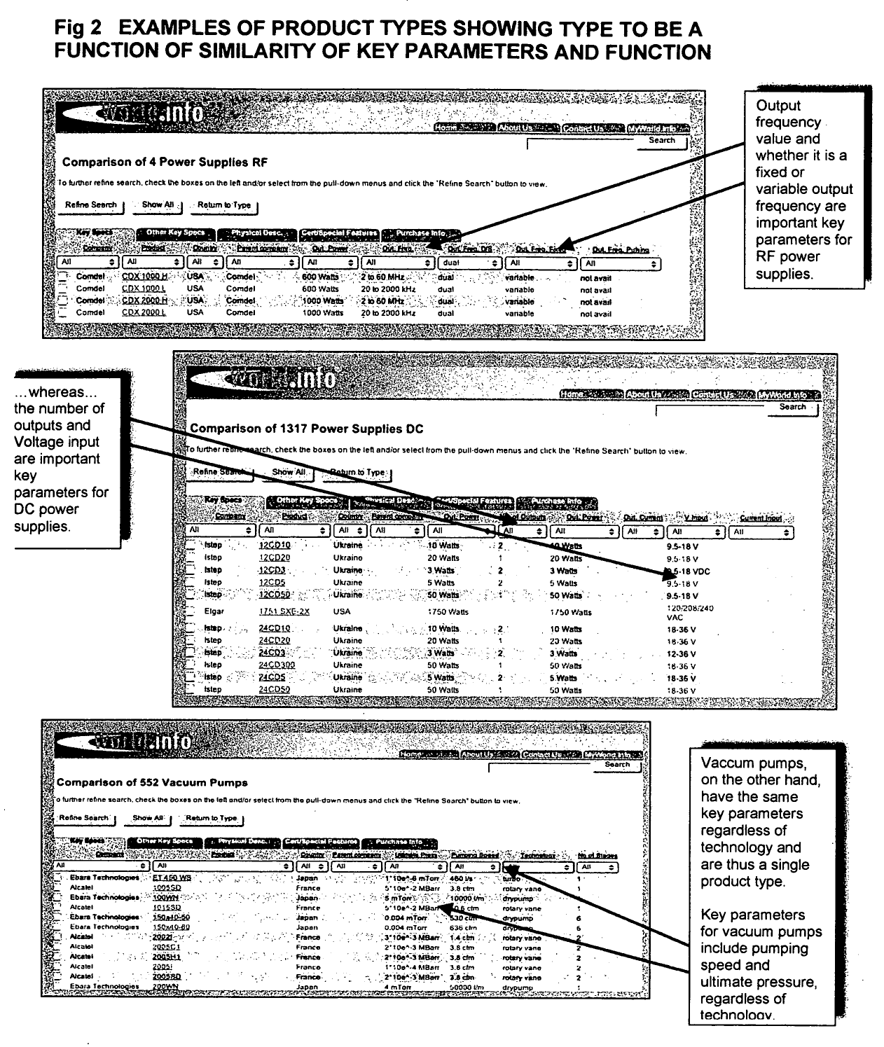

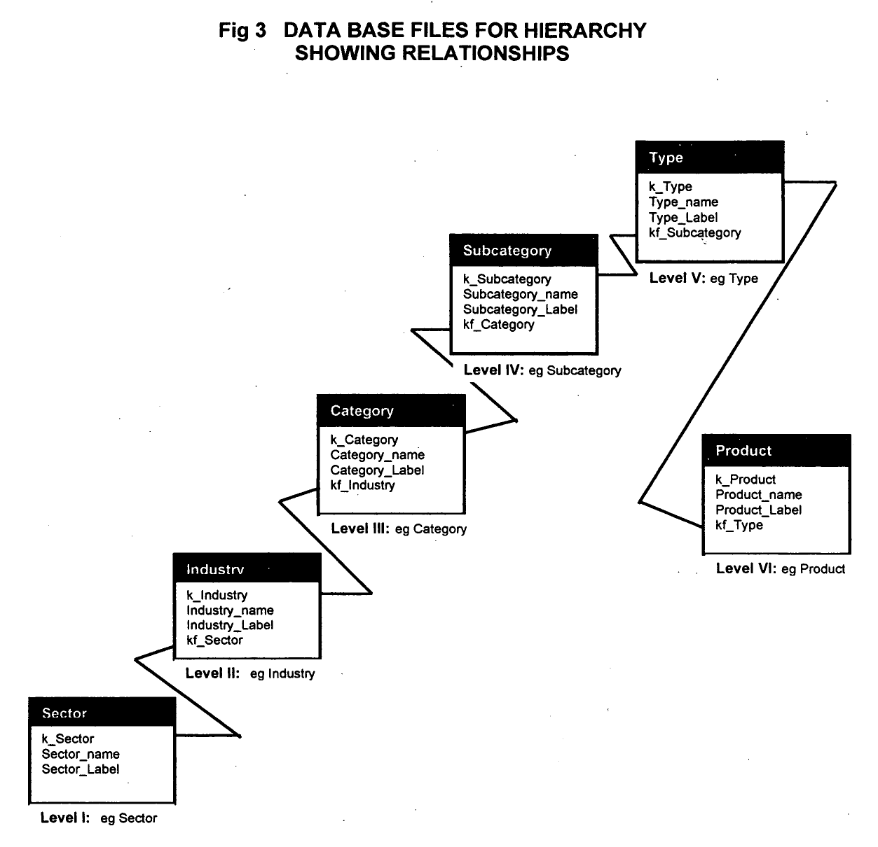

The following is a description of this database hierarchy as configured for a commercial and industrial marketing research tool. A relationship is created such that each Product (Level VI) is associated with one or more Product Types (Level V). Product Types are those Products where the key parameters or specifications will be the same or very similar. For example, two similar product types, AC Power Supplies and DC Power Supplies, have very different key parameters (FIG. 2). Product Type is associated with one or more Subcategories (Level IV). Each Subcategory is associated with one or more Categories (Level III). Each Category is associated with one or more Industries (Level II). Each Industry is associated with one or more Sectors (Level I). In this manner all products and services in the world can be organized for easy location and retrieval for comparison (FIG. 3)

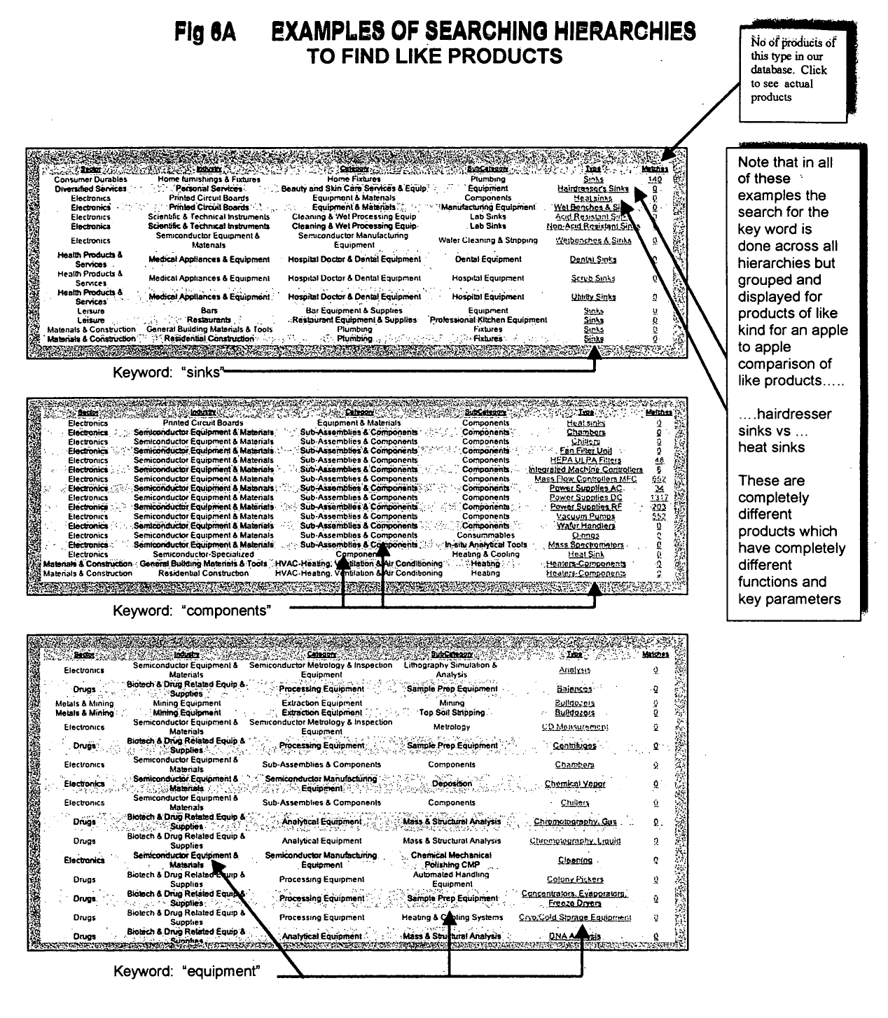

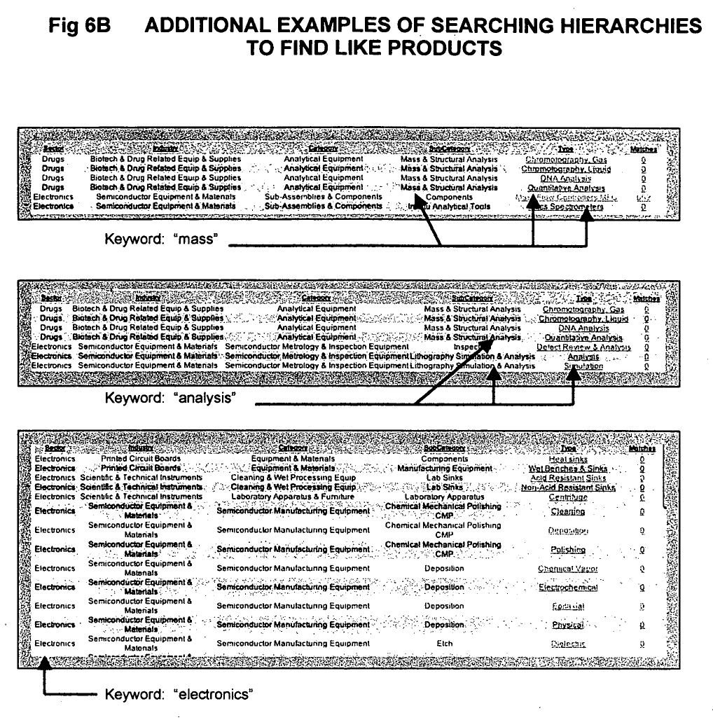

The user navigates through the hierarchy via the commonly used “point and click” computer technology, through the various levels of categorization of ever-increasing refinement. The user may enter the hierarchy at any level, and navigate his way up or down through the various levels as his needs dictate. Conceptual illustrations of the hierarchy, along with specific examples (screen shots of the World.info restricted access website) are given in FIGS. 2, 6A, 6B. These are given for illustrative purposes only, and in no way limit the scope or application of this invention. Any given commercial activity or product will appear within one, and may appear within more than one, of the hierarchical divisions listed below.

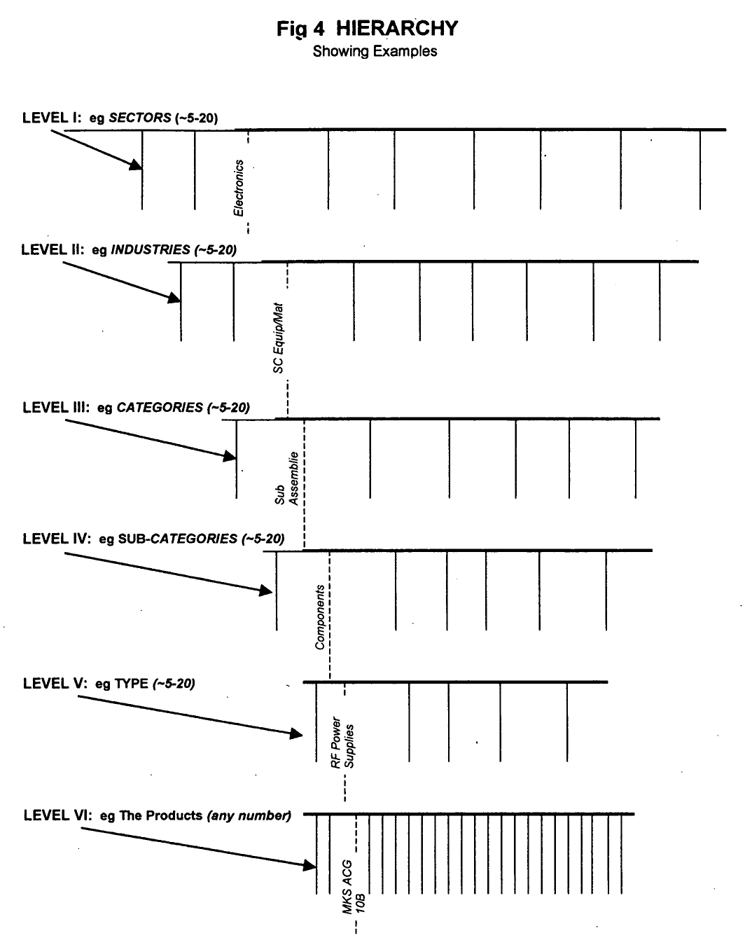

The hierarchy consists of six or more levels through which the user navigates so that, at the lowest level, many like products may be compared. Each level between the highest or Sector level, with thirty or more divisions, and the lowest, or Product Type level, which may have hundreds or even thousands of individual Products, may have within it any number of divisions, typically between five and thirty, with an average of ten. It will thus be seen that, using the average quantities of divisions given above, that the potential number of Products may be between (5-20 Product Types x 5-20 Subcategories x 5-20 Industries), or 625-160,000 Product Types per sector, with no limit to the number of Products per Product Type (FIG. 4). Note that without this hierarchy, sorting and typing products into 160,000 or more individual categories would be unwieldy and unusable.

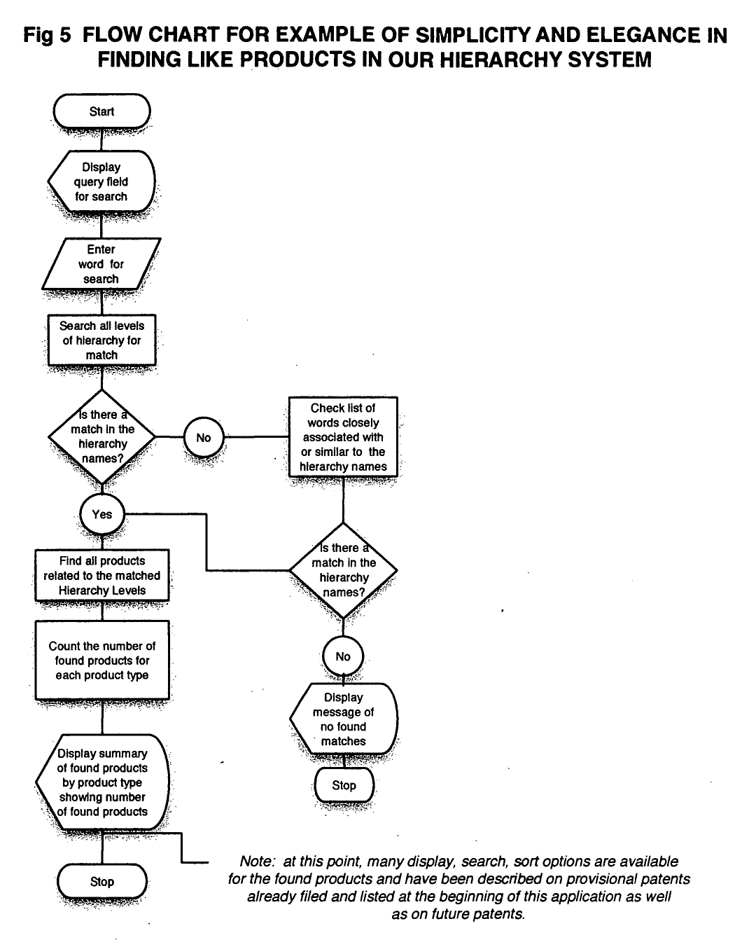

Each of the six levels of the hierarchy is given a name and may also be given a number. Using a key word or alphanumeric, all Products at any level of the hierarchy can be accessed through the hierarchy display (FIG. 5). Then any and all products associated with the key word will be available for comparison according to Product Type (FIG. 6A, 6B). Any level of the hierarchy can be used as a search, to view results for product in a broader or narrower range. The scope of the invention permits the creation of, or deletion of any number of subdivisions within any level, as future marketplace circumstances may require, and there is no limit to the potential number of levels, or subdivisions within any given level.

Product data is provided by the manufacturer or seller, in a data entry mechanism to be protected by a subsequent patent. Any new Product that is entered is immediately placed into its Product Type for ease of retrieval. Whenever a new product, service, or other item is entered into the database, the hierarchy level names for each level of hierarchy associated with that product are entered into the database by either manual, semiautomatic, or fully automatic method to be the subject of a future PTO application. Once each item is in the database and has the appropriate hierarchy level names assigned to it, retrieving only the field of items to which that specific item belongs, and “apples-to-apples” comparisons become possible. A given item may be found in more than one place or level within the hierarchy. For example, the same high-tech vacuum pump may be used in the semiconductor industry for one process, and in the aerospace industry for another.

The use of the term “product” as used in this patent application, while generally most useful in the marketplace arena to which the invention is primarily directed, is not intended to limit the scope of the invention to products only. The term “product” is construed to apply to any conceivable marketable item, object, service, performance, or idea. For example, its use includes, but is not limited to, such diverse items as the following: industrial or consumer products, fish ponds, county fairs, travel information, government contracts, international trade opportunities. The use of this hierarchical concept is intended to be a basis for the World.info search engine (referenced in the PPAs given in II above and others yet to be filed) and may, within the scope of this patent application, be extended to other, noncommercial uses.

Additions and subtractions of hierarchical levels or renaming of hierarchical levels can be made to this system without departing from the spirit and scope of the invention. There is no limit to the number of divisions within any given level. Any division of any level may be located using verbal, alphanumeric, or numeric identifiers. The term “product” as used in this application is construed to apply to any conceivable marketable or nonmarketable item, object, service, performance, or idea. This patent is intended to protect the business method of the use of the Fennell Hierarchy as described herein. Specific algorithms and programming language to enable the processing of this method will be filed in subsequent patents applications. The Figures showing the current configuration of the World.info website layouts are purely illustrative of its capacities, and may be altered in configuration and appearance without departing from the spirit and scope of the current invention.

The levels as currently configured for this patent application, are named as follows (FIG. 4);
1. SECTOR. The highest level of organization is known a “Sector.” The thirty Sector names assigned are those used on Wall Street in their Sector labeling. This allows the user to enter the hierarchy from the top down.
2. INDUSTRY. The second level of organization is known as “Industry.” Each of the Sectors is subdivided into a varying number of Industries (the word “industry” as used here may apply to other commercial activities than those commonly considered “heavy” or “industrial”) the names if which will be already familiar to the user.
3. CATEGORY. The third level is called “Category.” Within any given industry there will be a number of categories, the names of which will be familiar to the user who has navigated the hierarchy as far as the Industry level.
4. SUBCATEGORY. The fourth level of organization is called “Subcategory.” Within any given category, there will be a number of Subcategories, the names of which will be familiar to the user who has navigated the hierarchy as far as the Category level.
5. PRODUCT TYPE. The fifth level is called “Product Type.” Within any given Subcategory, there will be a number of Product Types, the names of which will be familiar to the user who has navigated the hierarchy as far as Subcategory.
6. PRODUCT. The lowest level is called “Product.” This level represents the specific products of specific manufacturers, as identified by model number or other designation, by those manufacturers. It is from the display of product types at this level that the user will make his ultimate selections for consideration and purchase.

Note that the hierarchy works from both ends, in that it (a) enables the buyer (user) to refine his search to satisfy his owns specific needs, and (b) enables the seller to have his product easily found and readily available to the user's search. It “levels the playing field”, reducing or eliminating the need for blanket advertising in the hopes of attracting new customers who might otherwise be unaware of the existence of his business or his products.

Unique systems and methods of navigation and display will be filed in subsequent patents.

1. A hierarchical system for categorizing and organizing commercial activity whereby all products can be located by means of said hierarchy, within one or or more levels, each consisting of an unlimited number of subdivisions (FIG. 4), comprising:
i. a plurality of six or more levels of hierarchy, in which the unique product comprises the lowest level;
ii. a second level, here designated product type, comprised of all unique products of a given type;
iii. a third level, here designated as subcategory, comprised of all product types sharing enough sufficient common features whereby they can be associated within a given subcategory;
iv. a fourth level, here designated category, comprised of all subcategories sharing sufficient common features whereby they can logically associated within a given category;
v. a fifth level, here designated industry, comprised of all categories sharing sufficient common features whereby they can be logically associated within a given industry;
vi. a sixth level, here designated sector, comprised of all industries sharing sufficient common features whereby they can be logically associated within a given sector.

2. The use of said hierarchy as a business method as a means of locating, comparing, and selecting products for retrieval, review, and/or purchase.

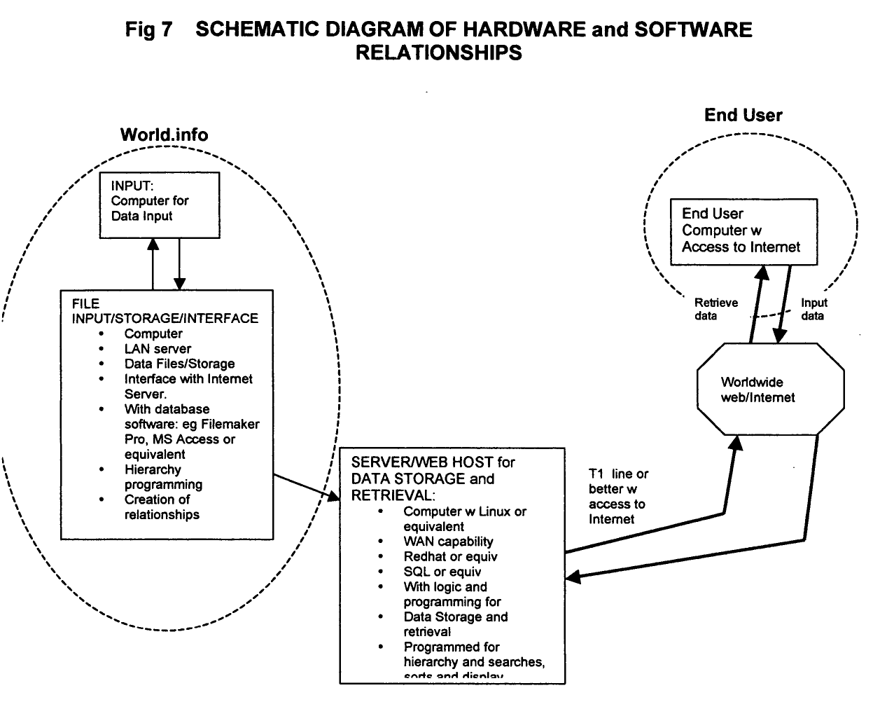

3. A system for organizing, processing, and locating products appropriate to the user's specific needs comprising (FIG. 7):
a. a computer terminal connected to the internet;
b. a storage means for storing data on a digital or electronic storage medium;
c. An algorithmic logic circuit configured to prepare the storage medium to store the data;
d. an algorithmic logic circuit creating a hierarchical structure of the stored data using predetermined levels of commercial activity in which any conceivable product may be situated, consisting of;
i. a plurality of six or more levels of hierarchy, in which the unique product comprises the lowest level;
ii. a second level, here designated product type, comprised all unique products of a given type;
iii. a third level, here designated as subcategory, comprised of all product types sharing enough sufficient common features whereby they can be associated within a given subcategory;
iv. a fourth level, here designated category, comprised of all subcategories sharing sufficient common features whereby they can logically associated within a given category;
v. a fifth level, here designated industry, comprised of all categories sharing sufficient common features whereby they can be logically associated within a given industry;
vi. a sixth level, here designated sector, comprised of all industries sharing sufficient common features whereby they can be logically associated within a given sector;
e. an algorithmic logic circuit for locating the stored product and product specification data within the hierarchy;
f. an algorithmic logic circuit for retrieval and display of located product data in a user-manipulated spreadsheet display format.

4. The said data processing system of claim #3 further used as a business method as a means for enabling the user to retrieve, review and compare for purchase specific products of a like kind.

5. The said algorithmic logic programming language enabling all of the logic circuits of claim #3 as a means for enabling of the data processing system described in claim #3 above.
